(19) United States
(12) Patent Application Publication
(10) Pub. No.: US 2026/0287556 A1
(43) Pub. Date: Sep. 24, 2026

(54) ARRANGEMENT FOR EXCITING GUIDED WAVES, APPARATUS AND METHODS

(71) Applicant: OMNIA INTEGRITY LTD, London (GB)

(72) Inventors: Alessandro DEMMA, London (GB); Alessandro BORDIGNON, London (GB)

(21) Appl. No.: 19/473,043

(22) PCT Filed: Apr. 4, 2024
(86) PCT No.: PCT/GB2024/050917

§ 371 Date: Oct. 6, 2025

(30) Foreign Application Priority Data
Apr. 5, 2023 (GB) 2305107.1
Dec. 5, 2023 (GB) 2318602.6

(51) Int. Cl. G01N 29/22; G01N 29/24; G01N 29/28

(52) U.S. Cl. CPC G01N 29/221; G01N 29/2437; G01N 29/28

(57) ABSTRACT

The present disclosure concerns an ultrasonic excitation arrangement (100) comprising a high-power ultrasonic transducer (10) and a housing (20), the housing (20) defining a volume of space (21) for accommodating an ultrasound-transmitting medium (22). The housing (20) is adapted such that, in use, the ultrasound-transmitting medium (22) receives ultrasound (1) emitted by the high-power ultrasonic transducer (10), and a test structure (30) receives the ultrasound (1) from the ultrasound-transmitting medium (22). As a result, high-amplitude guided waves can be uniformly excited on the test structure (30), and this allows extended guide-wave inspection ranges.

### TECHNICAL FIELD

The present invention relates to an arrangement for exciting guided waves, and more particularly to an arrangement for exciting guided waves that uses a high-power ultrasonic transducer for generating guided waves in a test structure. The present invention also relates to associated guided waves testing apparatus and methods. More particularly, the present invention relates to guided-wave excitation arrangements, apparatus and methods for non-destructive testing applications, such as for detecting defects, such as corrosion (but not solely) in a variety of structures such as elongated metal structures (such as tendons, bars, pipes, rods or rails) or metal plates, particularly when these test structures are embedded in highly attenuative materials such as concrete, earth, gravel, sand or rock, purely as examples. The present invention also relates to infrastructure (such as columns, bridges or the like) comprising said arrangements, or said apparatus, for example for continuous structural health monitoring.

### BACKGROUND

Mechanical guided waves are normally excited on test structures using one of three types of transducers:
a) piezoelectric transducers, which may be used in ‘dry contact’ with a test structure, or closely coupled to the test structure via a couplant, which usually is an ultrasound-transmitting gel;
b) magnetostrictive transducers, which use the magnetostrictive properties of a material to generate vibration; and,
c) electro-magnetic transducers (or EMATs), which use the principle of the Lorentz force.

These transducers, however, may only generate very limited guided-wave amplitudes (typically in the order of nanometres or even picometres) on the test structure, which means that only a very low amount of energy is associated with the guided waves travelling along the test structures. The standard approach with guided-wave testing is to inspect using a “pulse-echo” system. Pulse-echo systems use guided-wave reflections generated by the presence in the test structures of defects to detect their possible presence. In this way, defects such as corrosion, fatigue cracks or defects of different types may be detected in the components under examination. It is so that the type of guided waves excited in the test structure can be accurately controlled, that existing guided waves transducers use very low excitation power, which results into guided waves having abundantly sub-micron amplitudes (as mentioned above, typically in the order of nanometres or even picometres).

Further, the electronics normally associated with pulse-echo guided-wave testing systems serves both the excitation and reception sides of the testing, and this means that it necessarily provides a limited measurement dynamic range for the received guided waves, which normally have amplitudes lower than the amplitudes of the excited guided waves of one or more orders of magnitude.

Due to the low power of the above-mentioned guided-wave excitation methods, a known limitation of guided-wave inspection methods is their “range”, that is the space (more specifically, the length in the case of elongated test structures) that the guided waves can cover for testing purposes. This happens, for example, when a metal component such as a tendon, a bar, a pipe or some other elongated structural shape, such as a rail, is embedded in an attenuative medium such as concrete, is buried underground, or coated with attenuative coatings. The excited guided waves (which, as explained above, can already be said to have relatively low amplitudes) ‘leak’ into the outer attenuative material, and this exacerbates the problem of the limited range of inspection.

Further, all of the above transducers pose difficulties in achieving uniform excitation when the transducers are coupled to the test structures via irregular surfaces (for example, an uneven surface such as can be found on steel tendons).

Accordingly, there is a need to improve guided-wave inspection methods over the prior art.

At least one of the present solutions addresses at least some of the above limitations or disadvantages with respect to the prior art.

In addition, at least one of the present solutions enables the use of improved attenuation-based non-destructive testing methods, where the loss of amplitude or energy (or a combination of these) may be used to determine the possible presence of damage or defects, especially in the form of distributed damage, such as generalised (rather than highly localised) corrosion, within the test structures.

### SUMMARY OF THE INVENTION

According to an implementation described in the present disclosure, there is provided ultrasonic excitation arrangement comprising a high-power ultrasonic transducer and a housing. The housing defines a volume of space for accommodating an ultrasound-transmitting medium, such as a gel, or other liquid or semi-liquid medium (though in principle any medium capable of effectively transmitting ultrasound can be accommodated in said housing and on, around or in close proximity with the test structure, could be used). The housing is adapted such that, in use, the ultrasound-transmitting medium may receive ultrasound emitted by the high-power ultrasonic transducer. The housing is also adapted such that, in use, the test structure may receive the ultrasound from the ultrasound-transmitting medium.

Advantageously, the housing helps concentrate the high-power ultrasound level in the volume of space occupied by the ultrasound-transmitting medium. The ultrasound-transmitting medium will be subject to ultrasound directly received from the high-power ultrasonic transducer, as well as ultrasound that reverberate from the housing.

Advantageously, the ultrasound-transmitting medium excites the test structure uniformly, due to its uniformity of distribution all around and/or close to the test structure.

The above effects, in combination, advantageously determine uniform excitation of high-amplitude guide waves in the test structure. The excited guided waves have been measured to have amplitudes 40 decibels (dB) greater than corresponding amplitudes obtained using prior art guided-wave ultrasonic transducers; these values were measured using a standard ultrasonic receiver at the end-face of a bar-under like-for-like conditions. The guide waves can thus travel on the test structure for extended ranges, enabling improved testing and inspection.

The high-power ultrasonic transducer may be adapted to excite ultrasound having one or more frequency components in the spectrum between about 20 kHz and about 100 kHz. This range is chosen in the low-frequency ultrasonic spectrum. The low-frequency ultrasonic spectrum may be chosen to provide high vibration amplitudes at desired guide-wave vibration modes in the test structures.

To boost the high-power nature of the described implementations, the high-power ultrasonic transducer may comprise a mechanical resonator. The mechanical resonator may have at least one nominal resonance frequency in the spectrum between about 20 kHz and about 100 kHz, so as to be ‘matched’ to frequencies of excitation that are excitable by the high-power ultrasonic transducer.

The housing may be provided as a substantially rigid enclosure. Alternatively, the housing may comprise at least a substantially rigid enclosure portion. Optionally, said substantially rigid enclosure or enclosure portion is made of a metal, such as but not limited to steel.

Similarly, the housing may be provided as a substantially flexible enclosure or it may comprise a substantially flexible enclosure portion. Optionally, said substantially flexible enclosure or enclosure portion is made of a thin plastic material, such as a film or a foil. Optionally, said substantially flexible enclosure or enclosure portion is provided as a pouch made of a thin film or thin foil of plastic material.

In one preferred configuration, the housing comprises a substantially rigid enclosure portion to which a substantially flexible enclosure portion may be attached, such that the ultrasound-transmitting medium may fill a volume of space which is shared between the substantially rigid and flexible enclosure portions of the housing (that is, the volume of space filled with ultrasound-transmitting medium is defined by both the substantially rigid and flexible enclosure portions). In one preferred configuration, a pouch or pocket made of a thin film or foil of plastic material is appended to a substantially rigid enclosure portion, such as a metal box, metal cylinder or metal cone, just to name a few shape examples, so as to outwardly project from said rigid enclosure portion. An advantage of this configuration is that, then, the outwardly projecting pouch or pocket, filled with ultrasound-transmitting medium, may be conformed to, for example wrapped around, a suitable metal testing component, such as an elongated metal testing component. The inventors have recognised that it is not necessary for the test structure to occupy the volume of space filled with ultrasound-transmitting medium within a substantially rigid enclosure. Alternatively, the substantially flexible enclosure or enclosure portion may be adapted to conform to the test structure, for example, but not limited to, by wrapping around said test structure, which is particularly, but not solely, suited to elongated test structures. In this preferred configuration, the test structure remains outside the volume of space filled with ultrasound-transmitting medium.

The substantially rigid enclosure or enclosure portion of the housing may be provided, generally, in the shape or form of a parallelepiped or or of a cone or of a cylinder. Optionally, said substantially rigid enclosure or enclosure portion may comprise two or more assemblable parts, which may be useful for filling or refilling said volume of space with the ultrasound-transmitting medium. Optionally, the two or more assemblable parts may comprise a recipient part and a cover part, for practicality and ease of use. Optionally, said two or more assemblable parts may also be disassemblable, in other words, they may be taken apart for removal, or for servicing in connection with the ultrasound-transmitting medium.

Advantageously, the housing may comprise an aperture for receiving the high-power ultrasonic transducer, so that at least a part, such as a tip (i.e., a distal end), of the ultrasonic transducer, or of the mechanical resonator, when present, may directly occupy said volume of space for accommodating the ultrasound-transmitting medium. This means that, in use, the tip of the high-power ultrasonic transducer, or resonator, may be in direct contact with the ultrasound-transmitting medium. However, a different manner of transmitting the ultrasound generated by the high-power ultrasonic transducer may be implemented. For example, the housing may be provided integrally as part of the mechanical resonator. Alternatively, the mechanical resonator may be put directly in contact with the housing, externally thereof, or internally.

It is preferred, however, that the aperture be in direct communication with said volume of space for accommodating the ultrasound-transmitting medium.

The arrangement may further comprise a seal for sealing between the housing and the high-power ultrasonic transducer, so that the ultrasound-transmitting medium is sealingly contained in the volume of space provided inside the housing. The seal may be adapted to fit in or around the aperture for the high-power ultrasonic transducer. However, it is not necessary that the ultrasound-transmitting medium be confined in the housing. For example, depending on the implementation, one might implement a flow of ultrasound-transmitting medium through the housing.

The test structure itself may be part of the arrangement. However, it is envisaged that the arrangements described herein may be sold independently of the test structure, for example as a kit of parts including the high-power ultrasonic transducer and the housing. The housing may be adapted to fit specific test structures at the point of sale, or the housing may be so adapted on site, or in any event prior to, or in preparation of, an inspection or monitoring campaign.

The arrangements described herein are particularly suitable for test structures in the form of elongated metal components. However, as we will see here below, other test structures may be tested using the arrangements described herein.

In specific implementations, some of which are described herein, the metal component may be one of a bar, a rod, a tendon, a rail or a pipe.

Accordingly, the housing may comprise at least one opening for receiving a portion of said elongated metal component into said volume of space for accommodating the ultrasound-transmitting medium.

In some implementations described herein. The housing may comprise one and only one opening for receiving an end of said elongated metal component.

Said aperture and said opening may be relatively positioned on the housing such that, in use, the high-power ultrasonic transducer and the end of the elongated metal component may be disposed generally opposite one to the other. Optionally, the high-power ultrasonic transducer and the end of the elongated metal component may be generally disposed face-to-face. Optionally, the high-power ultrasonic transducer and said end of the elongated metal component may be disposed generally along a common straight line. However, other geometric configurations may be possible.

For example, the housing may comprise at least two openings for receiving a length of said elongated metal component. Accordingly, said aperture and said openings may be relatively positioned on the housing such that, in use, the high-power ultrasonic transducer and said end of the elongated metal component are disposed along intersecting or non-intersecting directions. For example, the high-power ultrasonic transducer and said length of the elongated metal component may be disposed substantially parallel one to the other. Alternatively, the high-power ultrasonic transducer and said end of the elongated metal component may be disposed substantially perpendicularly one to the other, or at another angle.

Alternatively, the test structure may be a metal plate, such as a flat plate, such as the base (or floor) of a storage tank, or a curved wall, such as a cylindrical wall of said storage tank. Optionally, said plate or wall may define a full circle, for example as in the case of a whole cylindrical tank, for example for storing fuel.

The housing may be specifically configured for testing non-elongated metal structures, such as the above plate or wall. For example, the housing may comprise at least one outlet for outputting the ultrasound received by the test structure from the ultrasound-transmitting medium. Said outlet may be provided on a wall or side of the housing which is flat, or curved, to conform to the shape of the plate or wall above-referenced.

Advantageously, said outlet may comprise a barrier for stopping the ultrasound-transmitting medium from outpouring from the housing onto the test-structure. Optionally, said barrier may comprises, or may be in the form of, a film. Alternatively, said barrier may be in the form of a sleeve, such as an inwardly projecting sleeve projecting into the housing, for accommodating a portion of the test structure.

In an alternative arrangement, the substantially flexible enclosure or enclosure portion is adapted to at least partially conform to, such as to wrap around, an elongated metal component. Optionally, the elongated metal component is one of: a bar, a rod, a tendon, a rail or a pipe. Optionally, said substantially flexible enclosure or enclosure portion is provided as a pouch made of a thin film or of a thin foil made of a plastic material. This configuration may be particularly advantageous when there is not much space available around the test structure to access the test structure with the excitation arrangement. Accordingly, rather than adapting a rigid housing around the test structure, such that the test structure is disposed within the housing, a flexible, shape-compliant pouch or pocket filled with ultrasound-transmitting medium, which may optionally depend from a rigid housing, may be provided to better access the test structure, while the test structure remains outside the housing, and outside the medium-filled volume of space defined by the housing.

It will be understood that the described arrangements may further comprise the ultrasound-transmitting medium. For example, a suitable ultrasound-transmitting gel may be sold as part of the aforementioned kit of parts.

In some implementations described herein, the high-power ultrasonic transducer may be piezoelectric. This lends itself well to the use of a simple housing (that is, a housing having a simple geometrical shape), as also described herein. However, at least in principle, it is not necessary to specify the use of a piezoelectric transducer, as far as the excited guided waves are of high-enough amplitudes to improve defect detection and/or inspection range over the prior art methods, as discussed herein.

Advantageously, the arrangement may also comprise one or more ultrasound receivers, which may optionally also be piezoelectric transducers, such as standard acoustic emission transducers, adapted to receive, and thus measure, any received guided waves at the excited frequencies and amplitudes.

Further, the arrangement may also comprise electronics for operating the high-power ultrasonic transducer and the one or more ultrasound receivers in transmission mode. The transmission mode may be with continuous ultrasonic transmission, or the ultrasound may be generated by the high-power ultrasonic transducer in bursts, in transient transmission mode. In this mode, it will also be possible to measure ‘time of flight’, between the time the emitted ultrasonic burst is generated by the high-power ultrasonic excitation arrangement and the time the ultrasonic burst is received, in the form of a guided-wave packet, by the receiving ultrasound transducer, as the skilled person would recognise.

The present disclosure therefore also sets forth non-destructive testing methods comprising exciting ultrasonic guided waves in a test structure using ultrasonic excitation arrangements as described herein.

The ultrasound receivers may be disposed on the test structure itself, or on a material that embeds said test structure. In a typical example, the test structure may be a tendon embedded in concrete.

The methods described herein may further comprise calculating a peak-amplitude and/or a frequency spectrum and/or an attenuation parameter and/or a parameter representative of energy of said received guided waves, which are received and measured by said ultrasound receivers.

A particular strength of the methods described herein is that the presence or absence of distributed defects (such as generalised, rather than localised, corrosion) in a test structure may be evaluated only from calculating said attenuation parameter of said measured guided waves. This is particularly useful in ‘monitoring’ applications, where the possible deterioration of the test structure is continuously or periodically assessed in time by looking at changes in an attenuation parameter. However, in other testing applications, the attenuation level between ultrasonic excitation and reception at two arbitrary selected points at a fixed distance one from the other may also be examined using said attenuation parameter. By changing the location of said arbitrarily selected points across the test structure, the baseline values of attenuation likely to correspond to unlikely presence of defects may be assessed. In this way, the measurement of additional attenuation over the baseline attenuation may be taken to mean the likely presence of, for example, generalised corrosion, between the two specific points being used for, respectively, the excitation and reception of guided waves.

In some implementations described herein, the test structure is a metal tendon and the method may further comprise estimating a tension in said metal tendon, since the properties of the excited guided waves are dependent on said tension. One application, for example, may be the detection of the presence of any tension in the tendon, or lack thereof.

When the methods described herein are applied to the non-destructive guided-wave testing of metal plates or the like, the methods may further comprise disposing a plurality of ultrasound receivers on a metal plate, exciting ultrasonic guided waves on the metal plate from a first selected position on the metal plate, exciting ultrasonic guided waves on the metal plate from at least one further selected position on the metal plate, and measuring the excited guided waves at the plurality of ultrasound receivers. Accordingly, not only the presence but also the position of a defect on the plate may be estimated.

Further, the method may further comprise exciting ultrasonic guided waves on the metal plate from a plurality of positions respectively proximal to the plurality of ultrasound receivers disposed on said metal plate. In this way, a complete defect ‘map’ of the area of the plate enclosed by the plurality of ultrasound receivers may be calculated, and graphically represented.

It would be possible to permanently or semi-permanently place the arrangements described herein on infrastructure such as reinforced concrete columns, highways, bridges, railroads, fuel storage tanks and the like. To achieve this, it may be required to prepare said infrastructure (which may comprise one or more test structures in the form of elongated metal components which are covered in attenuative material, such as concrete) for ultrasonic non-destructive testing by removing a portion of said attenuative material to expose one or more parts of the elongated metal components, and disposing one or more ultrasonic excitation arrangements as described herein on one or more respective exposed parts of said metal components.

One or more ultrasound receivers may then be disposed also on respective one or more exposed parts of said metal components. However, they could alternatively be disposed on an external surface of the attenuative material itself, such as on a concrete face of the infrastructure.

The present implementations will now be described, by way of example only, with reference to the accompanying drawings, in which:

### LIST OF DRAWINGS

FIG. 1 is a schematic representation of a first ultrasonic excitation arrangement as disclosed herein;

FIG. 2 is a schematic representation of a second ultrasonic excitation arrangement as also disclosed herein;

FIG. 3 is a schematic representation of a third ultrasonic excitation arrangement as also disclosed herein;

FIG. 4 is a schematic representation of a fourth ultrasonic excitation arrangement as also disclosed herein;

FIG. 5 is a schematic representation of a fifth ultrasonic excitation arrangement as also disclosed herein;

FIG. 6 is a top view of a sixth ultrasonic excitation arrangement as also disclosed herein, similar to that of FIG. 1, just prior to use;

FIG. 7 is a top view, slightly in perspective, of a seventh excitation arrangement as also disclosed herein, similar to that of FIG. 2, just prior to use;

FIG. 8 is a perspective view of an eighth excitation arrangement as also disclosed herein, similar to that of FIG. 5, while in use on a metal tendon;

FIG. 9 is a schematic representation of a ninth excitation arrangement as also disclosed herein, applied to the floor of a storage tank;

FIG. 10 is a close-up schematic representation of the excitation arrangement of FIG. 9;

FIG. 11 schematically represents an ultrasonic testing method for testing the storage tank floor of FIGS. 9 and 10;

FIG. 12 schematically represents an ultrasonic testing method for testing a wall of the storage tank of FIGS. 9, 10 and 11;

FIG. 13 is a perspective view of a test rod with a simulated distributed defect;

FIG. 14 shows the results of tests carried out on the rod of FIG. 13, using an ultrasonic testing arrangement as disclosed herein;

FIG. 15 shows an ultrasound receiver disposed on a reinforced concrete surface of a sample reinforced concrete infrastructure;

FIG. 16 shows the results of tests carried out on the infrastructure shown in FIG. 15;

FIG. 17 is a wider perspective view of the arrangement of FIG. 8, where tests are performed to detect tension in a tendon;

FIG. 18 shows the results of tests carried out on the tendon shown in FIGS. 8 and 17;

FIG. 19 shows, comparatively, two frequency spectra obtained from guided waves excited using a high-power ultrasonic excitation arrangement as described herein and measured on a flawless structure and a defective structure, respectively; and

FIG. 20 shows an alternative excitation arrangement comprising a metal cone and plastic pouch, which is filled with ultrasound-transmitting medium and is adapted to wrap around an elongated test structure.

### DESCRIPTION

The present disclosure arises from the desire of generating guided waves producing relatively high wave displacements in the test structure, well above the order of magnitude of nanometres which is typical of the prior art. With guided waves of this kind, it would be possible to achieve desirable inspection ranges even for test structures embedded in highly attenuative materials. It is a known problem that test structures embedded in highly attenuative materials have very limited guided-wave inspection ranges, which depend on the attenuation characteristics of the highly attenuative materials. When it is only possible to test short segments or areas of a test structure at a time (i.e., when the possible inspection ranges are very small), it becomes difficult or -in any event-at least expensive, and hence potentially commercially not viable, to test long (and/or large) structures such as tendons embedded in concrete.

While high-power ultrasonic transducers exist, they have typically not been applied to guided wave generation, due to difficulties in controlling the excitation (i.e., difficulties in making the excited modes reproducible). Careful selection of the excited modes, and modelling of the interaction of these guided waves with defects have traditionally been the focus of research and development in the field of guided waves. On the other side, high power ultrasound has traditionally been used in different applications such as ultrasonic cleaning, cavitation, welding, cutting and infra-red imaging.

The present disclosure proposes the use of high-power ultrasonic transducers for guided wave excitation, in a manner that makes it possible to reliably and uniformly excite guided waves in test structures at relatively high vibration amplitudes, which in turn enables defect detection with improved inspection ranges, using said guided waves.

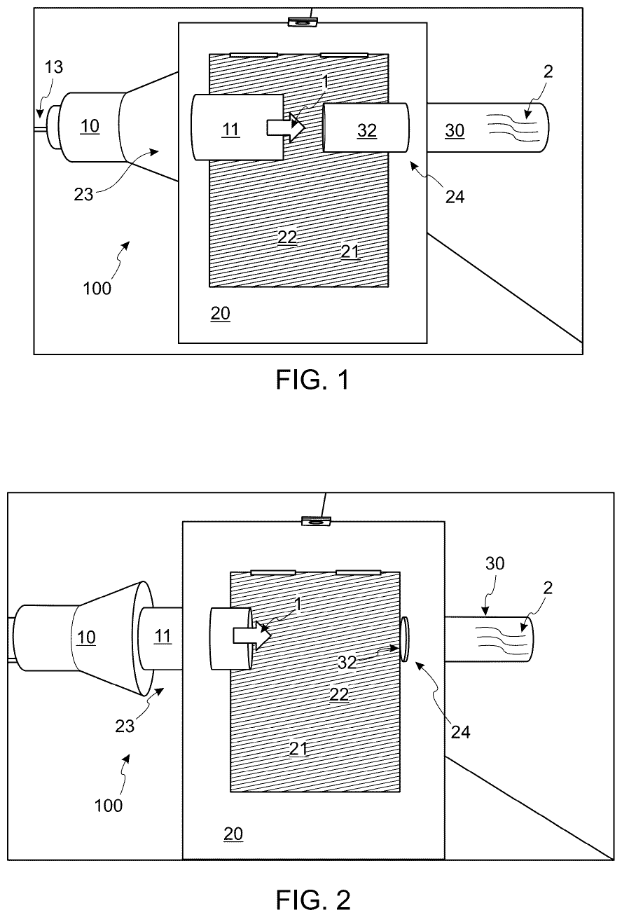

FIG. 1 schematically illustrates a first high-power ultrasonic excitation arrangement 100 disclosed herein. The ultrasonic excitation arrangement 100 in its essence comprises a high-power ultrasonic transducer 10 and a housing 20. The housing 20 defines a volume of space 21 for accommodating an ultrasound-transmitting medium 22. In FIG. 1, the volume of space 21 is filled with the ultrasound transmitting medium 22, or the ultrasound-transmitting medium 22 could be introduced at a later moment into the housing 20.

Importantly, the housing 20 is adapted such that, in use, the ultrasound-transmitting medium 22 may receive ultrasound 1 emitted by the high-power ultrasonic transducer 10 (in this case, the high-power ultrasonic transducer directly injects the ultrasound 1 into the ultrasound-transmitting medium 22, which in the described implementations is a gel). The housing 20 is also adapted to interact with a test structure 30, so that the test structure 30 may receive the ultrasound 1, which has been injected by the high-power ultrasonic transducer 10 into the gel 22—from the gel 22. As a result, high-amplitude guided waves 2 can be uniformly excited on the test structure 30.

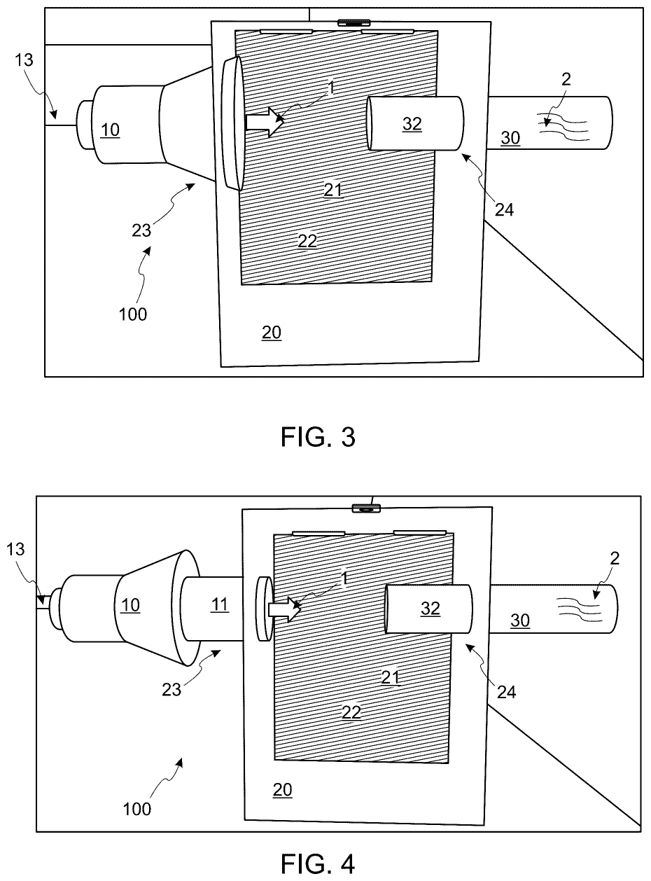

FIGS. 2 to 5 show variations of the high-power excitation arrangement 100 of FIG. 1. The same or similar test structures 30 are used in the set-ups shown in FIGS. 1 to 5. Further, the high-power ultrasonic transducer 10 is powered by the same electronics 13, part of which may be seen, for example, in FIG. 1. However, in FIGS. 1, 2, 4 and 5 the high-power ultrasonic transducer 10 comprises a mechanical resonator 11 (or “horn” 11), which is not present (and hence it is not shown) in the set-up of FIG. 3. In FIG. 3, the arrangement 100 comprises only an off-the-shelf high-power ultrasonic transducer 10, which in this case is a conventional 50 Watts ultrasonic cleaner (though other, similar transducers could be used).

The set-ups of FIGS. 1 and 2 differ for the lengths of insertion of an end 32 of the test structure 30 into the volume of space 21 filled with the gel 22, inside the housing 20: in FIG. 1, the test structure 30, in this case a metal rod measuring about 15 mm in diameter (as an example), projects for a few centimetres into the volume of space 21 filled with the gel 22; in FIG. 2, the end-face of the test structure 30 only marginally protrudes into said space 21. Also, the projections of the resonator 11 into said volume of space 21 are slightly different between FIGS. 1 and 2, as it can be seen. This, however, did not change the result of uniformly inducing high-amplitude guided waves into the test structure 30.

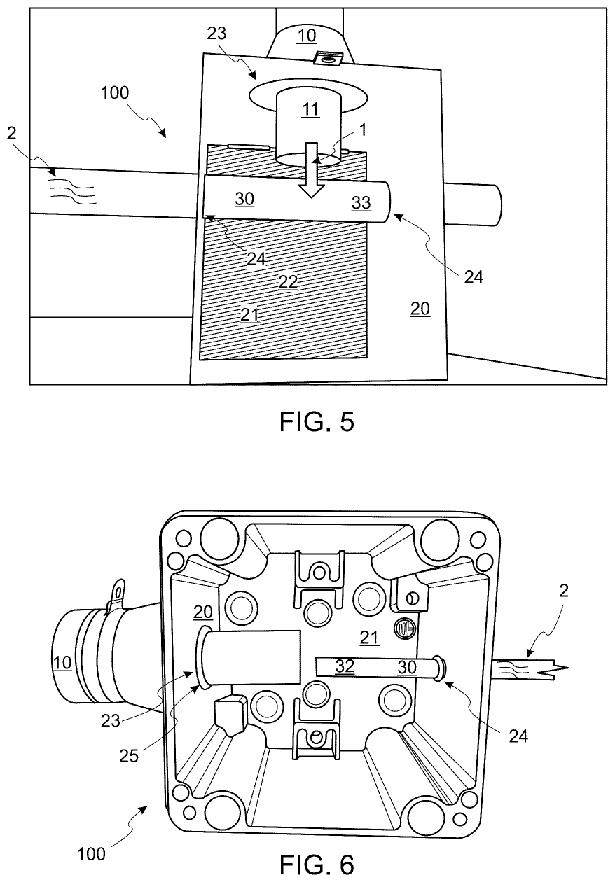

In FIG. 5, a whole length 33 of the test structure 30 is accommodated inside the housing 20, and in contact with the gel 22. The mechanical resonator 11 is practically fully inserted into the volume of space 21 accommodating the gel 22. The respective longitudinal axes defined by the transducer 10 and by the test structure 30 itself are substantially perpendicular one to the other, although it would be possible to have different angles, including a ‘zero’ angle, corresponding to a relation of parallelism between the longitudinal axes of the elongated test structure 30 and the horn 11. Again, this did not change the result of uniformly inducing high-amplitude guided waves into the test structure 30.

In FIG. 4, the mechanical resonator 11 is further withdrawn towards the outside of the housing 20 compared to the configurations shown in FIGS. 1 and 2. In FIG. 4, the mechanical resonator 11 has its distal-end face nearly flash, that is co-planar with, an inside surface of the housing 20, as it can be seen. Once more, this did not change the result of uniformly inducing high-amplitude guided waves into the test structure 30.

Despite the above-described differences, in all the configurations of FIGS. 1 to 5, the high-power ultrasonic transducer 10 (with or without mechanical resonator 11), independently of the configuration of the test structure 30 inside the housing 20, was able to excite guided waves 2 having the desired amplitudes into the test structures 30, as schematically depicted in each of FIGS. 1 to 5.

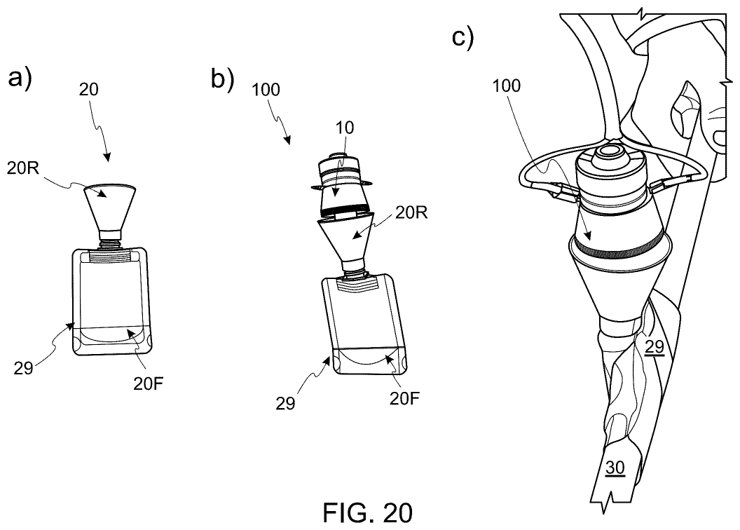

FIGS. 6, 7 and 8 show real-life, prototype implementations of high-power ultrasonic excitation arrangements 100 in principle similar to those shown in FIGS. 1, 2 and 5, respectively. The high-power ultrasonic arrangements 100 shown in these Figures are all devised using a parallelepiped-shaped box to provide the aforementioned housing 20. It is contemplated that commercial versions of the high-power ultrasonic excitation arrangements 100 will however comprise cylindrical enclosures 20, to better fit the geometry of the elongated metal structures 30 which are of particular interest herein. Other shapes may, however, be considered and implemented, depending on the applications. FIG. 20 described below shows, for example, one alternative excitation configuration which comprises a relatively rigid housing portion and a relatively flexible housing portion which cooperate to define the volume of space occupied by the gel.

The high-power ultrasonic excitation arrangement 100 of FIG. 6 closely follows the schematic ultrasonic excitation arrangement 100 shown in FIG. 1. However, in addition, in FIG. 6, a seal 25 in the shape of an O-ring is provided which serves to prevent outpour of ultrasound-transmitting gel 22 outside the housing 20, from excitation opening 23, between the resonator 11 and the wall of the housing wherefrom the resonator 11 is received.

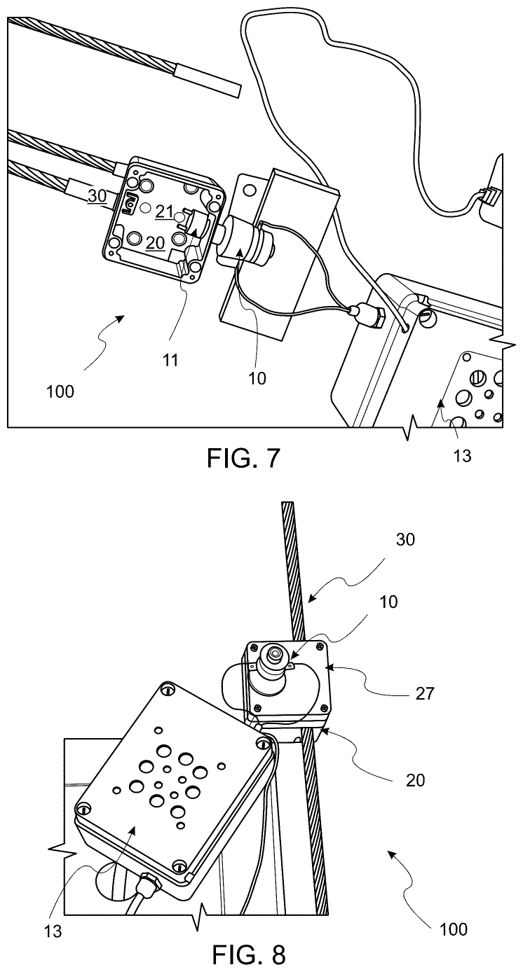

The high-power ultrasonic excitation arrangement 100 of FIG. 7 is instead a real-life implementation of the schematic ultrasonic excitation arrangement 100 illustrated in FIG. 2. The high-power ultrasonic excitation arrangement 100 of FIG. 8 is instead essentially consistent with the schematic ultrasonic excitation arrangement 100 schematically shown in FIG. 5: in particular, it may be noticed that in both arrangements 100 the longitudinal axes defined by the high-power ultrasonic transducer 10 and the test structure 30, respectively, do not intersect one another, and are substantially at 90 degrees one with respect to the other. After filling the volume of space 21 defined inside the housing 20 with the ultrasound-transmitting medium 22, the housing 20 (which in the presently described arrangement 100 is in the form of a square, walled recipient, or container) may be closed using a lid 27 (shown in FIG. 8). The lid 27 may be removed or replaced, as the case may be, for example if and when the ultrasound-transmitting medium 22 needs replacing or topping up.

FIGS. 7 and 8 also show further parts of the electronics 13 used to drive the high-power ultrasonic transducer 10. It is not within the remit of this disclosure to describe in detail such electronics 13, since these components will be fully consistent with components readily available from the prior art.

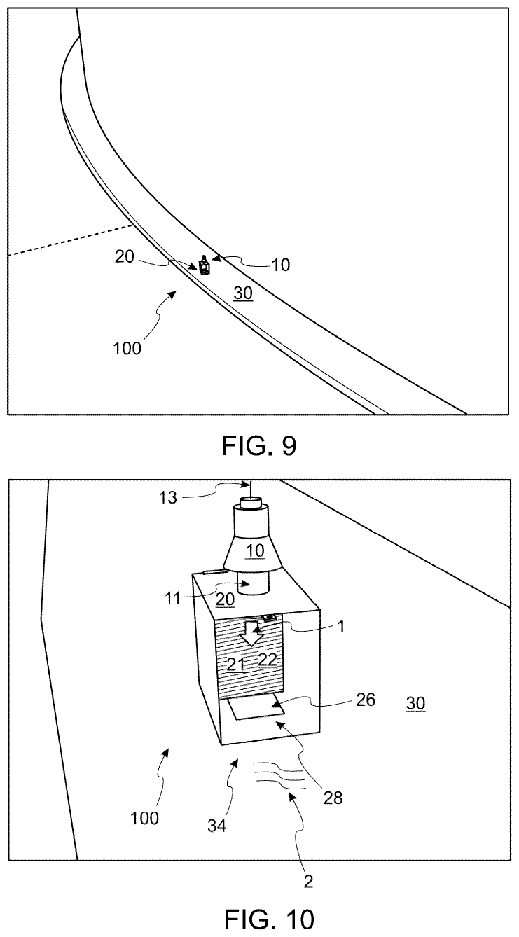

Before moving on to FIGS. 9 to 12, —which demonstrate the use of high-power ultrasonic arrangements 100 as described herein adapted to excite high-amplitude guided waves 2 into test structures 30 different from the elongated metal components shown in FIGS. 1 to 8 (namely, on essentially two-dimensional structures such as floors, plates or walls, such as floors and walls of fuel storage tanks, or the like)-some additional attention will now be given to those features of the housing 20 which effectively allow the high-power ultrasonic transducer 10 to inject ultrasound 1 into the ultrasound-transmitting medium 22 on one side, and to any metal elongated test structure 30 to receive most of said ultrasound 1 (part of its energy will inevitably dissipate due to friction or dispersion into, for example, the housing 20) from the ultrasound-transmitting medium 22.

More specifically, the ultrasonic excitation arrangements 100 of FIGS. 1 to 8 provide for the presence of one aperture 23 formed on a wall of the housing 20 for receiving the high-power ultrasonic transducer 10 and/or its resonator 11, if present, and for the presence of one or more openings 24 also formed on a wall of the housing 20 (which may be the same or a different wall compared to the wall of the housing 20 where the aperture 23 is provided) to allow either an end 32 of the elongated metal structure 30, or a whole length 33 thereof, as may be the case, to be accommodated into the housing 20, for being immersed in and surrounded by the ultrasound-transmitting medium 22 when this is present inside the housing 20.

Different adaptations of the housing 20 than those described herein may occur to the skilled person. The present disclosure teaches that the housing 20 is required to be adapted such that ultrasound 1 must be able to transfer from the high-power ultrasonic transducer 10 to the ultrasound-transmitting medium 22 present in the housing 20 first, and then, from the ultrasound-transmitting medium 22, the ultrasound 1 must transfer to the test structure 30 next for high-amplitude guided waves 2 to be generated on the test structure 30, uniformly. It is convenient if the high-power ultrasonic transducer 10 (with its horn 11, when provided) and the test-structure 30 are in direct contact with the ultrasound-transmitting medium 22 since this configuration requires minimal and inexpensive adaptations to the housing 20. However, other adaptations may be devised in which no such direct contact is required, such as that shown in FIGS. 9 and 10. In the case of FIG. 20, only the transducer/horn is in direct contact with the ultrasound-transmitting medium, but not the test component, as described further below.

FIG. 9 is a schematic representation of a further ultrasonic excitation arrangement 100 disclosed herein, for the inspection of a floor 30 (i.e., a plate) of a fuel storage tank. The arrangement 100 of FIGS. 9 and 10 (which shows a close-up of the arrangement 100 of FIG. 9) is in many respects similar to those of FIGS. 1 to 8. However, the housing 20, rather than defining an opening 24 for receiving part of the test structure 30, defines an ultrasound outlet 28 which is still in the form of an opening similar to that or those shown in FIGS. 1 to 8, but is used to transmit the ultrasound 1 from the gel 22 to the plate 30, which is now located outside the housing 20. In this described arrangement 100, the ultrasound outlet 28 also comprises a barrier 26 (provided in the described arrangement 100 in the form of a film, but other materials could be used). This barrier 26 not only prevents the ultrasound-transmitting medium 22 from spilling out the housing 20 but allows the ultrasound 1 to be transmitted to the floor 30 of the fuel storage tank via the barrier 26, so that guided waves 2 are generated, as shown in FIG. 10.

In a variation of the presently described arrangement, the film 26 could be provided in the form of an inwardly extending sleeve, for use with the configuration of any one of FIGS. 1, 3, 4 and 5. By using such a sleeve, contact between the test structure 30 and the ultrasound-transmitting gel 22 may advantageously be prevented, which may be desirable in some implementations. In the case of the excitation arrangement of FIG. 20 (which is described further below), the sleeve of plastic material projects outwardly from a metal cone, which performs a function similar to that of the box of FIGS. 1 to 10.

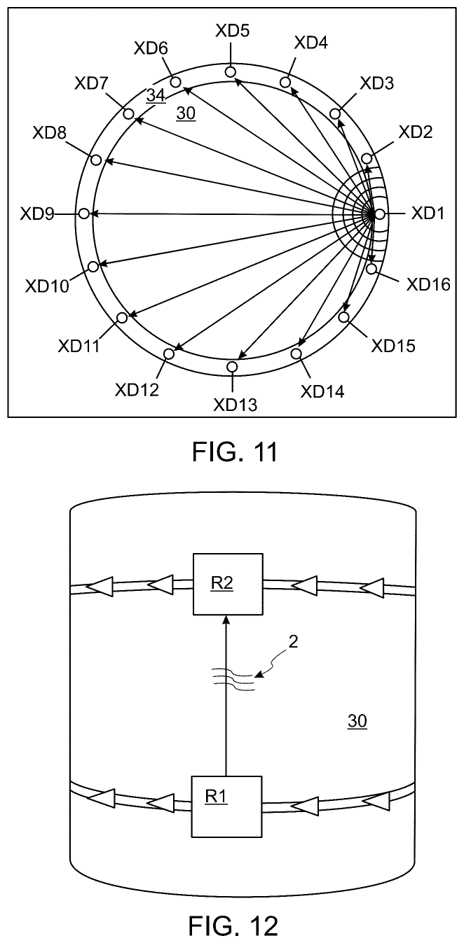

We will now describe some test results obtained on sample test structures 30 using the guided waves excitation arrangements 100 described herein. We will then return to FIGS. 11 and 12, since FIGS. 11 and 12 represent, conceptually, the extension of the testing of essentially one-dimensional (i.e., predominantly linear) test structures (such as rods, bars, tendons, rails or pipes) to essentially two-dimensional test structures such as plates or walls.

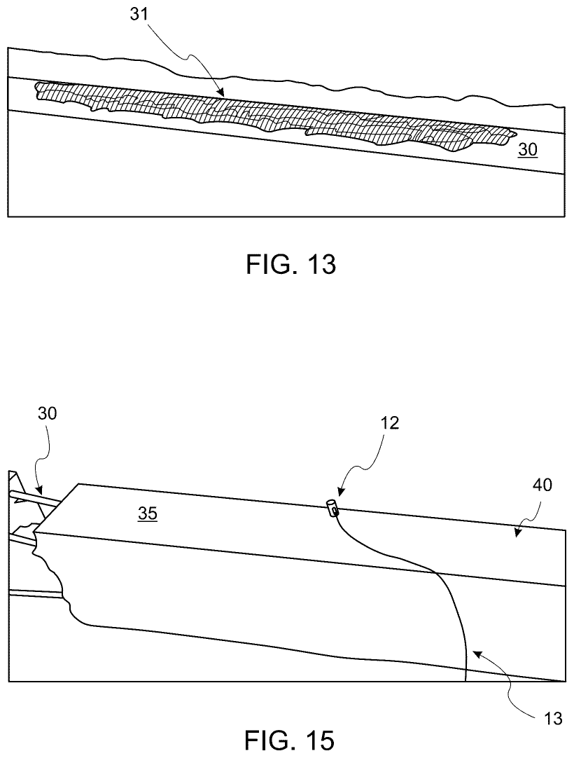

Remaining therefore, for the moment, in the domain of testing predominantly linear test structures 30, FIG. 13 is a perspective view of a test rod 30 with a simulated defect 31. The test rod 30 was specifically prepared for validating the use of the high-power ultrasonic excitation arrangements 100 described herein. Tests were initially carried out on the test rod 30 in the absence of the defect 31. The defect 31 was artificially introduced by removing a portion (a few millimetres) of rod material from its circumference, on one side of the test rod 30 only, for a length of about 10 to 15 centimetres. Experiments were then run using the set-ups of FIGS. 1 to 5. All set-ups were able to excite similar guided waves 2 on the test rod 30. However, the results that we present below are obtained from experiments using the set-up of FIG. 1. Accordingly, the high-power ultrasonic excitation arrangement 100 was used at one end of the test rod 30, and a standard acoustic-emission receiver 12 (an example of which is shown in FIG. 15) was used at the other end to receive the guided waves 2, directly in contact with an end-face of the test rod 30.

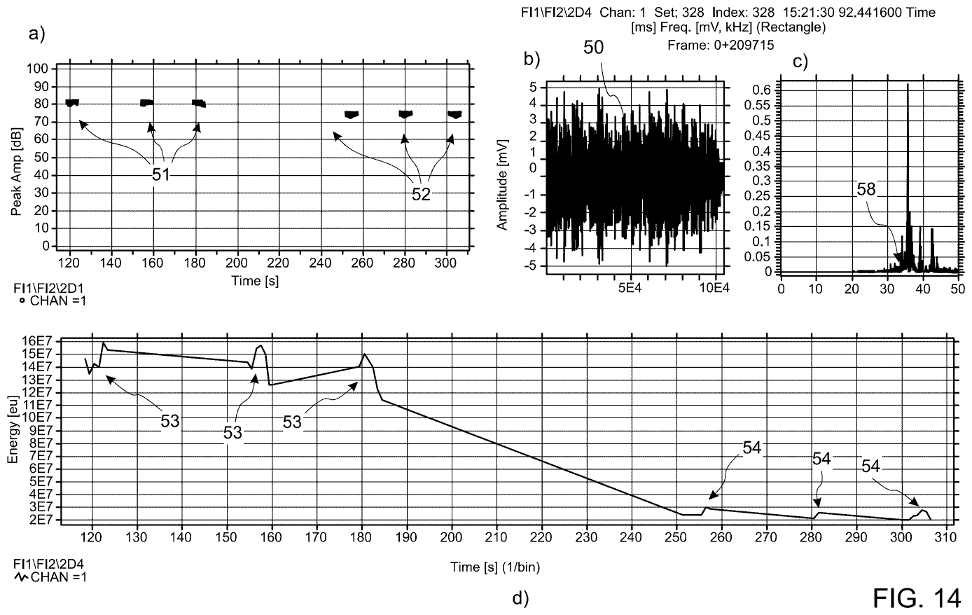

With reference now to FIG. 14, three tests were initially run with the metal test rod 30 in the absence of a defect 31. Both the peak amplitude 51 and energy values 53 of the measured ultrasonic signal 50 received by the receiver 12 were repeatable, as shown by:
FIG. 14 b), representing the response signal 50 measured by the ultrasound receiver 12;
FIG. 14 a) showing on the left the peak-amplitude values 51 of the three initial tests; and,
FIG. 14 d) showing also on the left the values of an energy parameter 53 also associated with the three initial tests.

With continued reference to FIG. 14, the above-described defect 31 was introduced to simulate general corrosion. Three more tests were run, under equivalent conditions. The simulated corrosion 31 caused attenuation in both the measured peak amplitude values 52 and energy parameter values 54 in these three subsequent tests. FIG. 14 c) shows a spectrum associated with the signal measured in one of the tests of the test rod 30 with the defect 31.

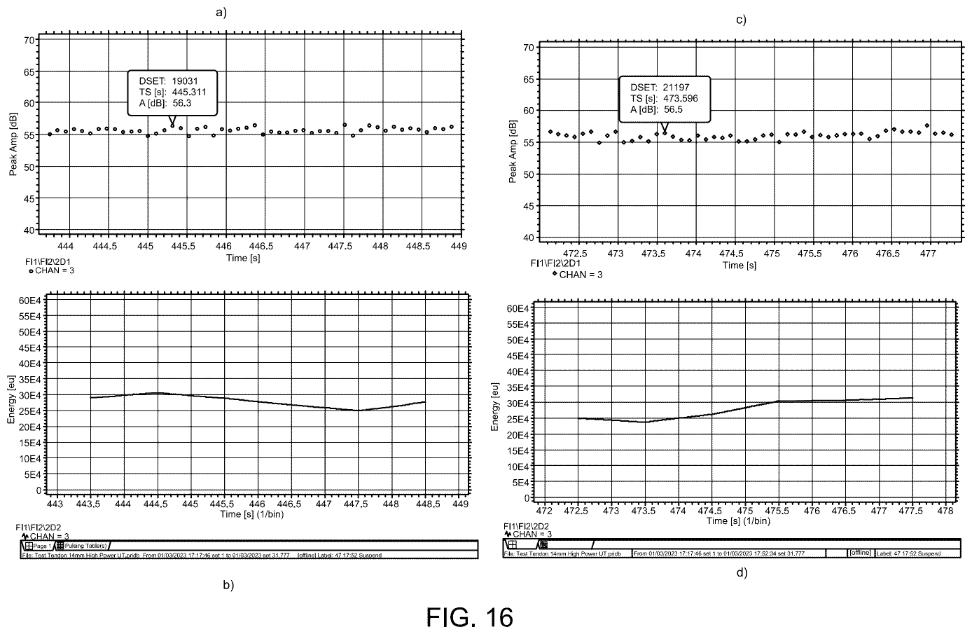

Moving on to FIG. 15, FIG. 15 shows an ultrasound receiver 12 disposed directly on a reinforced concrete surface 35. Tests were carried out to ascertain whether guided waves 2 as excited herein would be detected by the ultrasound receiver 12. The results of these tests are summarised in FIG. 16. FIG. 16 a) and b) to the left represent, respectively, peak amplitude values and the values associated with an energy parameter as a function of time, in a first test. FIG. 16 b) and d) to the right represent, respectively, the same peak amplitude values and the same energy parameter values as a function of time, in a second test. The tests show that the excited guided waves 2 have enough energy that the ultrasound receiver 12 is capable of picking them up from the reinforced concrete surface 35. This would not be possible with conventional guided waves in accordance with the prior art: the ultrasound receiver 12 would only be displaying noise, or in any event a borderline signal level (for example having a peak amplitude of only 40 dB) which would make it really difficult or even impossible to detect defects. It is expected that in the presence of a defect, for example a defect similar to the artificial defect 31 of FIG. 13, in the test structure 30 of FIG. 15, the peak amplitude values and the energy parameter values seen in FIG. 16 would drop consistently with the drops observed in FIG. 14 a) and d), that is of a few decibels (dB). These drops undoubtedly represent viable defect sensitivity.

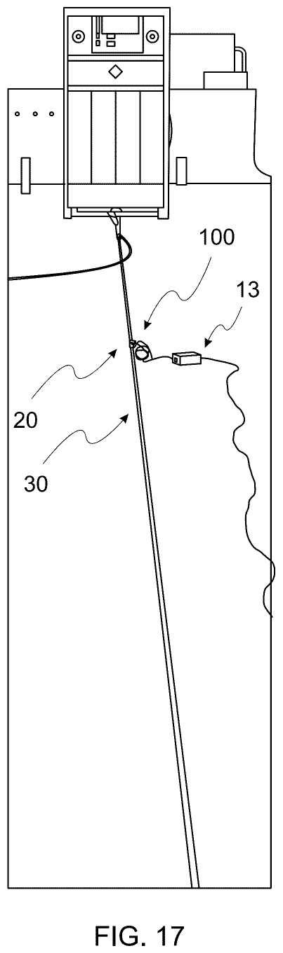

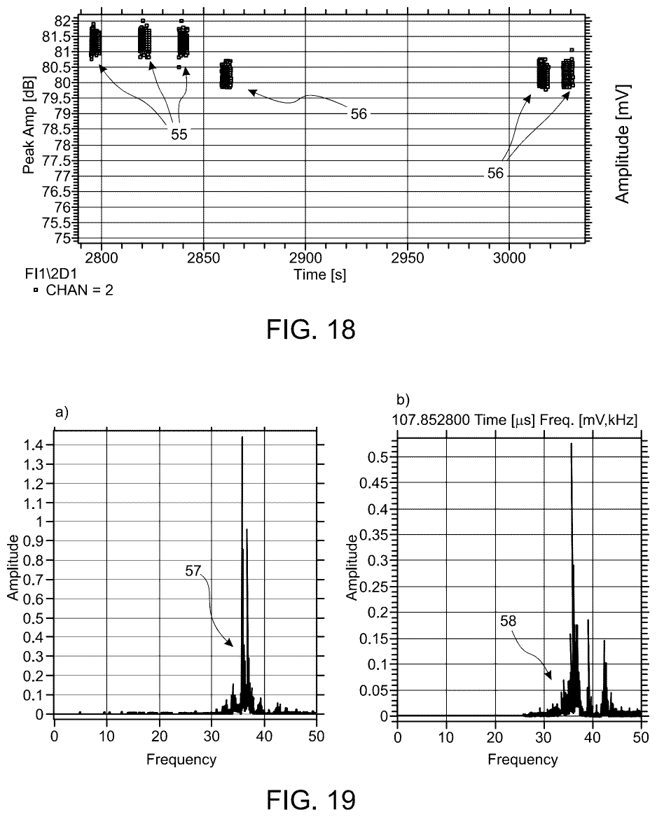

FIG. 17 shows from a wider angle the high-power ultrasonic excitation arrangement 100 already shown earlier in FIG. 8. Here, tests are carried out with or without tension in the tendon 30, and the results are plotted in FIG. 18, respectively. The tension was between 1000N and 1500N on a 14 mm diameter tendon in the first three tests, which returned higher peak amplitude values 55. The tension was completely released in the following three tests (this is what would happen in real life to a failed tendon, for example inside a concrete coat), with lower peak amplitude values 56. Given the relationship between tension and amplitude of signal, it would also be possible to use this technique to measure tension in a tendon.

FIG. 19 shows comparatively two frequency spectra 57, 58 obtained from guided waves excited using an arrangement as described herein and measured on a flawless structure and a defective structure, respectively. The difference in the frequency content of the two spectra is indicative of the presence of a defect.

Moving now, finally, to a discussion of FIGS. 11 and 12, FIG. 11 shows 16 positions from XD1 to XD16 on which ultrasound receivers 12 similar to that shown in FIG. 15 may be positioned. The test structure is a metal plate 30 as shown in FIGS. 9 and 10, and the corresponding high-power ultrasonic excitement arrangement 100 as also seen in FIGS. 9 and 10 is used. Guided waves 2 are generated initially on the metal plate 30 from a first selected position on the metal plate surface 34, for example close to position XD1. Then, the process is repeated with the excitation coming from a second selected position on the metal plate surface 34, for example close to XD2. Parameters such as ‘time of flight’ or ‘attenuation’ are then computed for each of the ultrasound receivers 12. By comparing these values, and plotting them as a function of space, a map can be displayed showing the location of potential defects on the plate, and not only their possible presence. To increase the accuracy of the map so obtained, the process may be repeated exciting, in turn, from positions close to each ultrasound receiver 12 shown in FIG. 11. Additionally, instead of using 16 locations around the circular plate 30 as shown in FIG. 11, more locations could be added (or fewer could be used).

FIG. 12 schematically depicts a method of inspecting the outer cylindrical wall 30 of the fuel storage tank referred to in connection with FIGS. 9 and 10. Two robots R1, R2 are devised, adapted to move on circumferences respectively at the base and at the top of the cylindrical wall 30 to be inspected, as shown in FIG. 12. The method comprises providing a high-power ultrasonic excitation arrangement of the type shown in FIGS. 9 and 10 on one of the two robots, for example R1. The method also comprises providing at least one ultrasound receiver 12 (similar in principle to the one shown in FIG. 15) on the second robot D2. By moving the robots R1 and R2 simultaneously along the aforementioned circumferences, it is possible to inspect the whole area of the cylindrical wall for defects, preferably using detection parameters such as ‘time of flight’ or attenuation. Moving the robots R1 and R2 simultaneously is not the only strategy applicable. Alternatively, one robot, for example R1, carrying a high-power ultrasonic excitation arrangement 100 as described herein may be kept at a fixed location, and the robot R2 carrying the ultrasound receiver may be moved to measure the guided waves 2 at various locations around the respective circumference, or vice versa. In any case, maps similar in principle to those obtained using the arrangement of FIG. 11 may be obtained.

An inspector wishing to use the present high-power ultrasonic excitation arrangements 100 will be required to use ear protection, just like in other high-power ultrasonic applications such as ultrasonic cleaning, welding, cutting or ultrasonic infrared imaging. Noise non-discernible to the human ear (because arising from frequencies well in excess of 20 kHz) yet having high levels of intensity (for example 80 dB or more) may otherwise damage ear tissues. On the contrary, this is not a necessary requirement in guided wave applications.

While in the present disclosure a number of applications have been discussed with the aim of illustrating one or more advantages related to the introduction of the present high-power ultrasonic excitation arrangements 100, the list of these applications is not to be considered exhaustive. The skilled person would be able to use the present teachings in a vast array of, for example, non-destructive testing applications.

One such application is for example illustrated with reference to FIG. 20. FIG. 20 a) shows a hollow conic metal enclosure 20R coupled to a substantially flexible housing portion 20F, which in this case is implemented as a plastic pouch 29 made of a thin plastic material. The conic enclosure 20R and plastic pouch 29 together define a volume of space 21 which is, in use, occupied by an ultrasound-transmitting medium (not shown in FIG. 20). The cone 20R is substantially rigid, or, in any event, relatively more rigid than the pouch 29; the cone 20R could alternatively be made of a rigid plastic material. In FIG. 20 b), the ultrasonic horn 10 is inserted into the space 21 delimited by the hollow cone. This serves to generate ultrasound in, for example, gel that has previously been provided to fill the conical cavity 21. Since the gel also occupies the volume of space 21 defined by the plastic pouch 29, the ultrasound propagates to the inner volume of the pouch 29. In FIG. 20 c), the pouch 29 is at least partially wrapped around a test structure 30, which in this case is a metal pipe, and the ultrasonic transducer/horn 10 is powered by electric connections, as necessary, before excitation may be provided to the test structure 30 and tests can be carried out. The test structure 30, in this configuration, is not disposed within the housing 20, but it is the flexible portion 20F of the housing 20 that is conformed to (more particularly, in this instance, fully wrapped around) the test structure 30, with similar excitation results. This is possible because the ultrasound 1 is still able to reverberate inside the ultrasound-transmitting medium, and the thin walls of the plastic pouch 29 are capable of transmitting significantly the ultrasound 1 externally, directly into the test structure 30, thereby generating the desired guided waves 2.

The excitation arrangement of FIG. 20 is better suited to test structures 30 which are more difficult to access, given the flexibility of the pouch 29 which may be easily conformed to the shape of the test structure 30. It will also be appreciated that, while in FIG. 20, the plastic pouch 29 only defines a portion of the volume of space 21 of the whole housing 20 filled with an ultrasound-transmitting medium (not shown), in principle, the housing 20 may entirely be made of a substantially flexible and/or shape-compliant material, just like the housing may otherwise entirely be made using a relatively rigid material such as a metal (as described herein above) or a relatively rigid plastic material, such as a thermosetting plastic. The test structure may accordingly be disposed internally or externally of the housing, depending on the intended application and suitable configurations therefor-so long as it can eventually receive the ultrasonic waves that have developed in the ultrasound-transmitting medium-filled volume of space defined by the housing.

The present disclosure focusses around mechanical aspects related to the excitation of high-amplitude guided waves on test structures and, as such, does not disclose details relating to any electronics that may be used to drive the transducers on the excitation side, or to measure the excited guided waves on the reception side. The skilled person would find in the prior art electronics suitable for the present purposes.

Further, while the calculation of certain parameters related to the excited guided wave has been referred to herein, again the list of these referred-to parameters is not to be interpreted exhaustively. Depending on the specific applications, certain other parameters may be better suited for detecting the defects being investigated, and the skilled person would be able to select the appropriate parameters based on the teachings in the prior art.

### LIST OF REFERENCE NUMBERS USED HEREIN

1 Ultrasound
2 Guided waves
10 High-power ultrasonic transducer
11 Mechanical resonator
12 Ultrasound receiver
13 Electronics
20 Housing
20R Substantially and/or relatively rigid portion of housing
20F Substantially and/or relatively flexible portion of housing
21 Volume of space in housing
22 Ultrasound-transmitting medium
23 Aperture
24 Opening
25 Seal
26 Barrier
27 Lid
28 Ultrasound outlet (from the housing)
29 Plastic pouch or pocket
30 Test structure
31 Defect to be detected
32 End of test structure
33 Length of test structure
34 Surface of test structure
35 Attenuative material
40 Infrastructure
50 Measured ultrasonic signal at ultrasound receiver
51 Peak amplitude (no defect)
52 Peak amplitude (defect)
53 Energy parameter (no defect)
54 Energy parameter (defect)
55 Peak amplitude (tension)
56 Peak amplitude (no tension)
57 Frequency spectrum (no defect)
58 Frequency spectrum (defect)
100 Ultrasonic excitation arrangement
XD1, XD2, XD3, ..., XD16 Positions of ultrasound receivers on test structure
R1 First robot
R2 Second robot

1. Ultrasonic excitation arrangement comprising:
a high-power ultrasonic transducer; and,
a housing, the housing defining a volume of space for accommodating an ultrasound-transmitting medium,
wherein the housing is adapted such that, in use, the ultrasound-transmitting medium accommodated in the housing receives ultrasound emitted by the high-power ultrasonic transducer, and such that a test structure being tested using the ultrasonic excitation arrangement receives the ultrasound from the ultrasound-transmitting medium.

2. The arrangement of claim 1, wherein the high-power ultrasonic transducer is adapted to excite ultrasound having one or more frequency components in the spectrum between 20 kHz and 100 kHz.

3. The arrangement of claim 1, wherein
the high-power ultrasonic transducer comprises a mechanical resonator; and
the mechanical resonator has at least one nominal resonance frequency in the spectrum between 20 kHz and 100 KHz.

4. The arrangement of claim 1, wherein the high-power ultrasonic transducer is selected to generate displacements on an active transducer surface measuring 1 micrometre or more.

5. The arrangement of claim 1, wherein the housing is provided as a rigid enclosure, or the housing comprises a substantially rigid enclosure portion.

6. The arrangement of claim 1, wherein
the housing is provided as a flexible enclosure, or the housing comprises a flexible enclosure portion; and
said flexible enclosure or said enclosure portion is made of a thin plastic material, such as a film or a foil.

7. The arrangement of claim 1, wherein
the housing comprises a rigid enclosure portion and a flexible enclosure portion; and
the flexible enclosure portion is provided as a pocket or pouch of a thin plastic material attached to and projecting outwardly from the rigid enclosure portion of said housing.

8. The arrangement of claim 5, wherein said rigid enclosure or enclosure portion, is generally in the shape of a parallelepiped, of a cone or of a cylinder.

9. The arrangement of claim 1, wherein the housing comprises an aperture for receiving the high-power ultrasonic transducer.

10. The arrangement of claim 9, wherein the aperture is in communication with said volume of space.

11. The arrangement of claim 9, wherein the arrangement further comprises a seal for sealing between the housing and the high-power ultrasonic transducer.

12. The arrangement of claim 1, wherein the arrangement further comprises said test structure.

13. The arrangement of claim 12, wherein said test structure is an elongated metal component.

14. The arrangement of claim 13, wherein the metal component is one of: a bar, a rod, a tendon, a rail or a pipe.

15. The arrangement of claim 13, wherein the housing comprises at least one opening for receiving a portion of said elongated metal component into said volume of space for accommodating an ultrasound-transmitting medium.

16. The arrangement of claim 9 and wherein the housing comprises one and only one opening for receiving an end of an elongated metal component, and
said aperture and said opening are relatively positioned such that, in use, the high-power ultrasonic transducer and said end of the elongated metal component are disposed generally opposite one to the other.

17. The arrangement of claim 9, wherein
the housing comprises at least two openings for receiving a length of an elongated metal component, and
said aperture and said openings are positioned such that, in use, the high-power ultrasonic transducer and said end of the elongated metal component are disposed along non-intersecting directions.

18. The arrangement of claim 12, wherein said test structure is a metal plate, such as a flat plate or a curved wall, such as a cylindrical wall.

19. The arrangement of claim 18, wherein the housing comprises at least one outlet for outputting the ultrasound received by the test structure from the ultrasound-transmitting medium.

20. The arrangement of claim 19, wherein said outlet comprises a barrier for stopping the ultrasound-transmitting medium from outpouring from the housing onto the test-structure.

21. The arrangement of claim 20, wherein said barrier comprises, or is in the form of, a film, such as a thin film or thin foil, made of a plastic material.

22. The arrangement of claim 7, wherein
said flexible enclosure or said enclosure portion is adapted to at least partially wrap around an elongated metal component;
the elongated metal component is one of: a bar, a rod, a tendon, a rail or a pipe; and
said flexible enclosure or said enclosure portion is provided as a pouch made of a thin film or of a thin foil of a plastic material.

23. The arrangement of claim 1, wherein the arrangement further comprises the ultrasound-transmitting medium.

24. The arrangement claim 1, wherein the high-power ultrasonic transducer is piezoelectric.

25. Non-destructive testing apparatus comprising the ultrasonic excitation arrangement of claim 1, and one or more ultrasound receivers,

26. (canceled)

27. Non-destructive testing method comprising:
exciting ultrasonic guided waves in the test structure using the ultrasonic excitation arrangement of claim 1.

28-37. (canceled)

38. Infrastructure comprising the ultrasonic excitation arrangement according to claim 1.

39-43. (canceled)
